(19) United States
(12) Patent Application Publication
(10) Pub. No.: US 2013/0003582 A1
(43) Pub. Date: Jan. 3, 2013

(54) NETWORK SPLITTING DEVICE, SYSTEM AND METHOD USING VIRTUAL ENVIRONMENTS

(75) Inventors: Heean Park, Seoul (KR); Kyung Wan Kang, Seoul (KR); Kwang Tae Kim, Seoul (KR)

(73) Assignee: AHNLAB, INC., Gyeonggi-do (KR)

(21) Appl. No.: 13/582,247

(22) PCT Filed: Mar. 3, 2011
(86) PCT No.: PCT/KR2011/001468

§ 371 Date: Aug. 31, 2012

(30) Foreign Application Priority Data
Mar. 5, 2010 (KR) 10-2010-0020055

(51) Int. Cl. H04L 12/26

(52) U.S. Cl. 370/252

(57) ABSTRACT

A network separation apparatus allows a user terminal, connected to an internal network, to connect an external network. The network separation apparatus includes a packet transmission/reception unit to receive a packet generated in a virtual environment on the user terminal and transmit the packet either to the external network or the internal network. The apparatus also includes a packet analysis unit to analyze the packet received from the packet transmission/reception unit and a packet processing unit to allow the packet to be transmitted to the external network or the internal network, separately, based on an analysis result of the packet from the packet analysis unit and a preset packet processing policy.

### FIELD OF THE INVENTION

The present invention relates to a network separation system, and more particularly, to a network separation apparatus, system and method, which transmits a packet generated from a user terminal such as a computer or the like, separately either to an external network such as the internet or the like, or an internal network such as an intranet or the like, based on a virtual environment.

### BACKGROUND OF THE INVENTION

In recent years, with the rapid development of computer technology, the extensive use of computers and computer networks has become possible. Thus, public organizations, companies or the like are actively using not only internal networks but also external networks such as the Internet or the like, in order to conduct research and use e-mail transmission and file transfer at external locations to carry out business.

As external networks which are vulnerable to external attacks, such as attacks over the Internet or the like, are in widespread use, public organizations, companies or the like deploy and operate firewalls to keep important internal information secure. However, such firewalls cannot provide a complete protection of important internal information against intentional external attacks because they cannot prevent accesses which bypass them.

Thus, in recent, a network separation technology has been introduced that separates an internal network and an external network from each other, thereby attempting to protect important internal information against attacks made over the external network.

The network separation technology refers to a technology that organizes two or more networks that have been separated based on the purpose and do not allow network packet data to be transferred between the networks. Thus, the network separation technology prevents other networks from being damaged even when one network has been infiltrated by hacking or the like. The prior art related to the network separation technology is disclosed in Korean Unexamined Patent Publication No 2002-10887 (published on Feb. 6, 2002).

The network separation technology disclosed in the prior art may be roughly divided into physical network separation and logical network separation. The physical network separation is configured to employ two personal computers (PCs) with one for an internal network and the other for an external network, physically completely separated from each other, which requires no particular technology. The logical network separation is constructed mainly through a server-based computing (SBC) solution at present, by which a PC is connected to a server at a remote location by network connection to enjoy the Internet on a guest operating system (OS) running on the server.

However, the physical network separation technology requires each user to be equipped with a business PC and an internet PC or server equipment, and requires the large-scale installation of network lines and the addition of equipment such as firewalls, routers and the like. Thus, the implementation of network separation incurs considerable costs and the use of two PCs by one user causes degradation in user convenience. Meanwhile, the logical network separation technology has the problem of low working efficiency caused by performance degradation or the like because multiple users commonly access and use one server.

### SUMMARY OF THE INVENTION

In view of the above, the present invention provides a network separation apparatus, system and method, which enables logical network separation of an external network and an internal network based on a virtual environment, with only a smallest possible change to a network and without physical separation of an external network and an internal network, to separately transmit a packet generated from a user terminal, such as a computer or the like, to either the external network or the internal network.

In accordance with a first aspect of the present invention, there is provided a network separation apparatus which allows a user terminal, connected to an internal network, to connect an external network, the apparatus including: a packet transmission/reception unit configured to receive a packet generated in a virtual environment on the user terminal and transmit the packet either to the external network or the internal network; a packet analysis unit configured to analyze the packet received from the packet transmission/reception unit; and a packet processing unit configured to allow the packet to be transmitted to the external network or the internal network, separately, based on an analysis result of the packet from the packet analysis unit and a preset packet processing policy.

In accordance with a second aspect of the present invention, there is provided a network separation system, the system including: a user terminal, connected to an internal network, configured to transmit a packet generated in a virtual environment via the internal network; and a network separation apparatus configured to analyze the packet received from the user terminal, and selectively transmitting the packet either to an external network or the internal network, separately, based on an analysis result and a preset packet processing policy.

In accordance with a third aspect of the present invention, there is provided a method for network separation, the method including: generating a virtual environment when there is a need for a connection between a user terminal, connected to an internal network, and an external network; receiving a packet generated in the virtual environment; analyzing the received packet; and selectively transmitting the packet to either the external network or the internal network, separately, based on an analysis result of the packet and a preset packet processing policy.

In accordance with the present invention, to achieve network separation using a virtual environment, a virtual environment for accessing an external network is realized in multiple user terminals, which are connected to an internal network, only a packet of which destination IP address represents the external network, among packets generated in the virtual environment, is transmitted to the external network, and a packet of which destination IP address represents the internal network is identified as a packet attempting access to the internal network with malicious intent and prevented from being transmitted to the internal network. Thus, the present invention has the advantage of performing network separation in a more simple and reliable way.

Further, the present invention enables network separation only by a smallest possible change to a network, without physical separation of an external network and an internal network, by transmitting a packet generated from a user terminal, separately either to the external network or the internal network based on a virtual environment, thereby minimizing costs incurred in the network separation.

### BRIEF DESCRIPTION OF THE DRAWINGS

FIG. 1 shows the network configuration of a network separation system in accordance with an embodiment of the present invention;

FIG. 2 illustrates an exemplary screen displayed on a display unit in a user terminal when a virtual environment is executed;

FIG. 3 illustrates a detailed block diagram of a network separation apparatus in accordance with an embodiment of the present invention; and

FIGS. 4A and 4B illustrate operational flow diagrams of a logical network separation performed in a network separation system in accordance with an embodiment of the present invention.

### DETAILED DESCRIPTION OF THE EMBODIMENTS

Hereinafter, the operating principles of the present invention will be described in detail below with reference to the accompanying drawings. In the following description, well-known functions or constitutions will not be described in detail if they would obscure the invention in unnecessary detail. Further, the terminologies to be described below are defined in consideration of functions in the invention and may vary depending on a user's or operator's intention or practice.

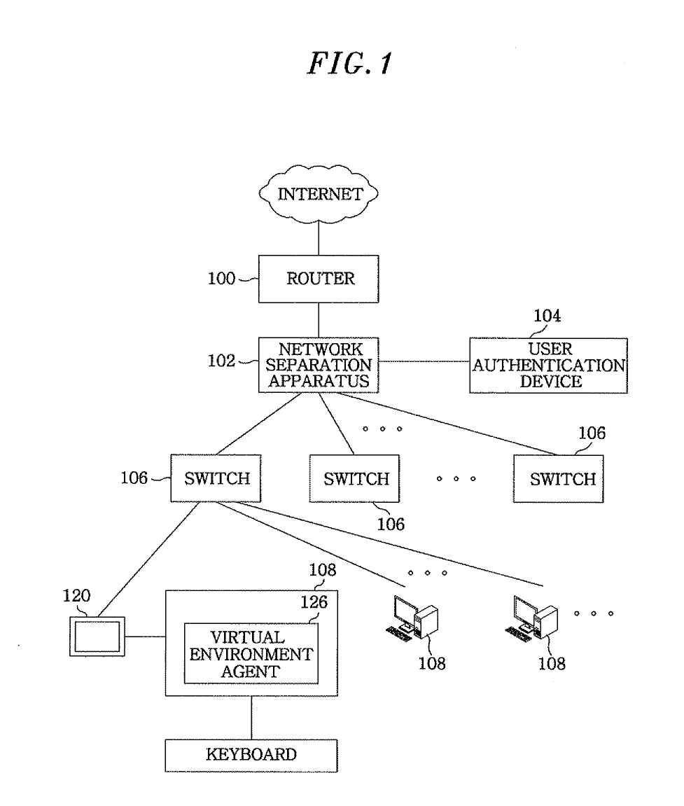

FIG. 1 illustrates the configuration of a network separation system for logically separating an internal network and an external network based on a virtual environment in accordance with an embodiment of the present invention.

Referring to FIG. 1, the network separation system of the present invention includes a network separation apparatus 102, a user terminal 108 such as a personal computer or the like capable of supporting a virtual environment, a switch 106, a user authentication device 104, and the like.

A router 100 refers to a device that reads a destination address from packets to designate the most appropriate communication path, and transmits the packets to other external communication networks via the designated communication path. The router 100 provides an interface that enables the user terminal 108 connected to an internal network to access an external network such as the Internet or the like.

The user terminal 108 is a computer terminal having an internet-accessibility such as a personal computer (PC) or the like, and is connected to the internal network through the switch 106 and to the external network such as the Internet or the like through the network separation apparatus 102. The user terminal 108 is equipped with a virtual environment agent 126 to allow the virtual environment agent 126 to generate a virtual environment logically separated from the internal network upon execution of a process requiring a connection to the external network and to execute the process in the virtual environment. Further, the user terminal 108 transmits packets, generated by the execution of a process related to a connection to the external network in the virtual environment, to the network separation apparatus 102 by tunneling.

In other words, the user terminal 108 executes a process, such as an Internet Explorer or the like attempting a connection to the external network, in the virtual environment, and is connected to the external network through the virtual environment. Thus, this prevents a malicious code or the like, which may be introduced via the external network, from infiltrating the internal network, thereby protecting other user terminals to be connected to the internal network and enabling them to use the external network safely.

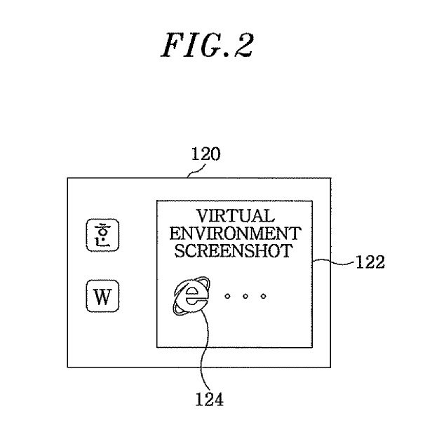

Upon execution of the virtual environment by the virtual environment agent 126 in order to access the external network, the user terminal 108, for example, as shown in FIG. 2, separately displays a virtual environment screenshot 122 for external network access on the display unit 120 in the user terminal 108. In addition, icons 124 for processes, such as an Internet Explorer or the like, related to the external network access are displayed within the virtual environment screenshot 122 so that the user can execute a desired process within the virtual environment to access the external network.

The network separation apparatus 102 analyzes the packets provided from the user terminal 108 through the switch 106, and selectively transmits the packets to the internal network or the external network based on the analysis result and a packet processing policy. In this regard, the packet processing policy may be set in advance by a manager (not shown) who manages the network separation system.

In this embodiment, a description has been made with respect to the packet processing policy, which is set to transmit the packets generated in the virtual environment only to the external network. However, on the contrary, the packet processing policy may be set to transmit the packets generated in the virtual environment only to the internal network and block transmission to the external network.

Specifically, the network separation apparatus 102 in accordance with this embodiment checks the destination IP address of the packet generated and transmitted by the process executed via the virtual environment in the user terminal 108, and transmits the packet to the external network if it is a network IP address representing the external network. However, if the destination IP address of the packet is identified as a network IP address representing the internal network, despite the fact that the packet is a packet generated in the virtual environment, it is determined that there happens an IP change with malicious intent, and the packet does not transmitted to the internal network but instead discarded.

In order to differentiate a packet generated in the virtual environment from a packet generated in the internal network, the packet generated in the virtual environment may be configured to have a specific destination IP address different from the destination IP address of the packet transmitted from the internal network. Such a specific destination IP address is used for the network separation apparatus 102 to transmit the packet generated in the virtual environment with more accuracy to the external network or internal network designated based on the packet processing policy.

Meanwhile, when the virtual environment is launched in the user terminal 108, a request for authentication for the user of the virtual environment is provided from the user terminal 108 to the network separation apparatus 102. The network separation apparatus 102 transmits the authentication request to the user authentication device 104. Authentication information issued by the user authentication device 104 to authenticate whether or not the user of the terminal 108 is a normal user is then stored in the network separation apparatus 102.

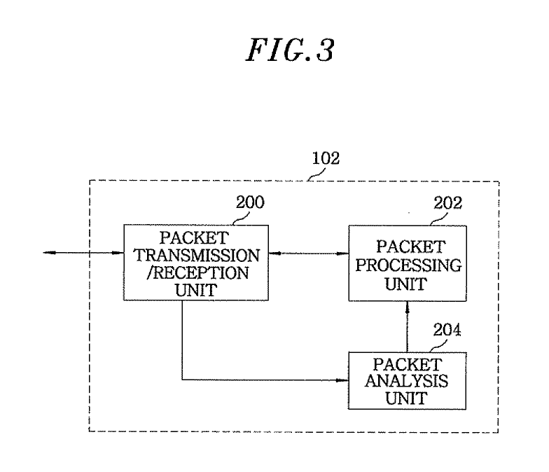

FIG. 3 is a detailed block diagram of the network separation apparatus 102 in accordance with an embodiment of the present invention. The network separation apparatus 102 includes a packet transmission/reception unit 200, a packet analysis unit 204, and a packet processing unit 202.

The packet transmission/reception unit 200 transfers, to the packet analysis unit 204, packets provided from multiple user terminals 108 connected to the internal network. Further, the packet transmission/reception unit 200 transmits packets processed by the packet processing unit 202 to the external network or the internal network based on the packet processing policy.

The packet analysis unit 204 analyzes a packet from the user terminal 108, which is received from the packet transmission/reception unit 200, checks whether or not the packet is generated from the virtual environment on the user terminal 108, and extracts the destination IP address of the packet. An analysis result containing the destination IP address of the packet is transferred to the packet processing unit 202.

The packet processing unit 202 separately transmits the packet to either the external network or the internal network, through the packet transmission/reception unit 200 based on the analysis result of the packet provided from the packet analysis unit 204 and the preset packet processing policy.

More specifically, if the packet is identified as being generated by a process executed in the virtual environment on the user terminal 108 based on the analysis result obtained by the packet analysis unit 204, the packet processing unit 202 checks whether or not the destination IP address of the packet is an IP address representing the external network.

In this embodiment, the packet processing policy is established to transmit a packet from a virtual environment only to an external network. Thus, if the destination IP address of the packet is an IP address representing the external network, the packet processing unit 202 identifies the packet as a normal packet and transmits it to the external network. On the other hand, if the destination IP address of the packet is an IP address representing the internal network, the packet is identified as a packet attempting access to the internal network with malicious intent, and the packet does not transmitted to the internal network but instead discarded, thereby blocking the access to the internal network.

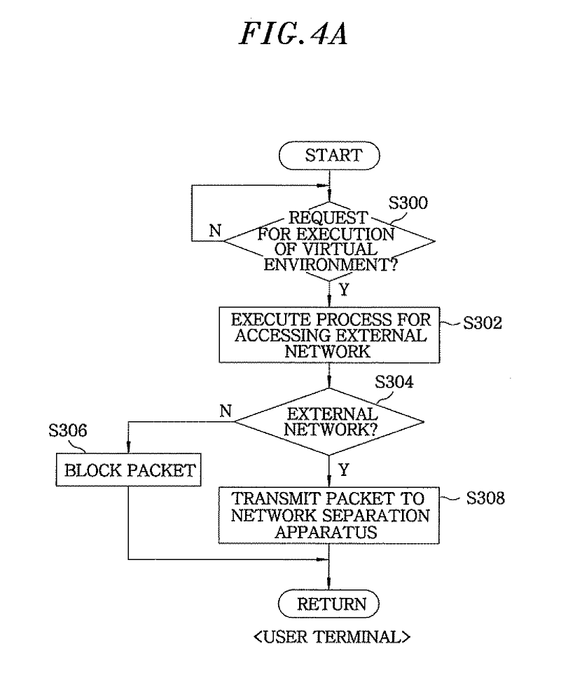

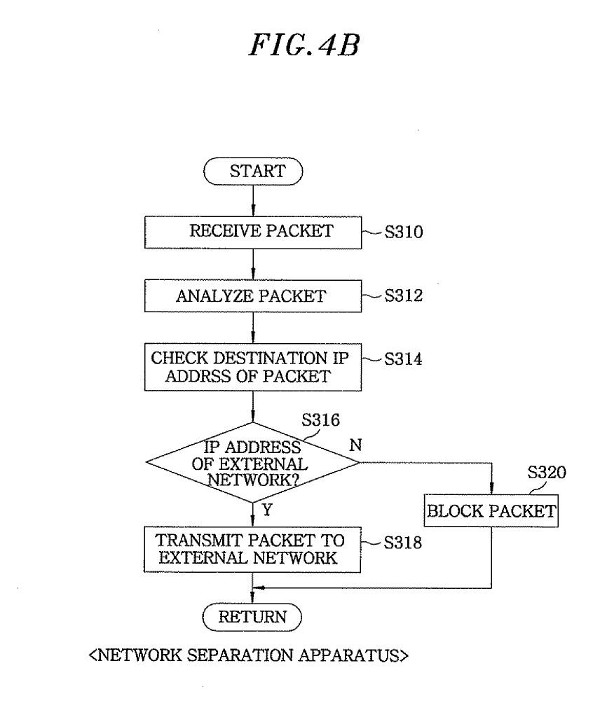

FIGS. 4A and 4B are operational flow diagram illustrating a logical network separation of an internal network and an external network in a network separation system in accordance with an embodiment of the present invention. In particularly, FIG. 4A shows an operational flow diagram performed by in the user terminal 108, and FIG. 4B shows an operational flow diagram performed in the network separation apparatus 102.

When a user wants to access an external network, such as the Internet, using the user terminal 108 such as a computer or the like connected to an internal network of a company or the like, the user firstly executes the virtual environment on his/her user terminal 108, and executes a process, such as an Internet Explorer or the like, for accessing the external network in the virtual environment.

In this regard, the user terminal 108 is equipped with the virtual environment agent 126 so that a process for accessing the external network can be executed only in the virtual environment of the user terminal 108. The virtual environment agent 126 is controlled not to access the external network in a general work environment other than the virtual environment, even if the process for accessing the external network is executed.

Referring to FIG. 4A, upon a request for execution of the virtual environment from the user in step S300, the virtual environment agent 126 generates the virtual environment, and displays the separate virtual environment screenshot 122 for accessing the external network on the display unit 120 of the user terminal 108, for example, as shown in FIG. 2. Further, the icons 124 for a process, such as an Internet Explorer or the like, related to the external network access are displayed within the virtual environment screenshot 122 so that the user can execute a desired process within the virtual environment to access the external network.

Thus, when the user selects a desired process within the virtual environment screenshot 122 and makes a request for execution, the user terminal 108 executes the process requested by the user to be executed in the virtual environment in step S302.

In step S304, a packet is generated in the virtual environment by the execution of the process and the user terminal 108 identifies the destination IP address of the generated packet to check whether the destination of the packet is destined for the external network.

As a result of checking in step S304, if the destination IP address of the packet is an IP address representing the internal network, the user terminal 108 proceeds to step S306 to discard the packet and block access to the internal network.

On the other hand, as a result of checking in step S304, if the destination IP address of the packet is an IP address representing the external network, the user terminal 108 proceeds to step S308 to transmit the packet to the network separation apparatus 102.

At this point, the packet transmitted to the external network as described above passes through the switch 106 routing the multiple user terminals 108 within the internal network, and is directly transmitted to the network separation apparatus 102 by tunneling. This prevents the packet generated in the virtual environment from being transmitted to other user terminals 108 through the switch 106 without passing through the network separation apparatus 102.

Referring to FIG. 4B, the network separation apparatus 102 receives the packet requested to be transmitted to the external network from the user terminal 108 as before in step S310. The network separation apparatus 102 analyzes the received packet to check whether or not the packet is generated in the virtual environment on the user terminal 108 and extract the destination IP address of the packet in step S312.

Subsequently, the network separation apparatus 102 identifies the destination IP address of the packet analyzed and checks whether the destination IP address is an IP address representing the external network or an IP address representing the internal network in step S314.

In step S316, as a result of checking, if the destination IP address of the packet is an IP address representing the external network, the network separation apparatus 102 proceeds to step S318 to identify the packet transmitted from the user terminal 108 as a normal packet and transmit it to the external network.

On the other hand, in step S316, if the destination IP address of the packet is an IP address representing the internal network, the network separation apparatus 102 identifies the packet as a packet attempting access to the internal network with malicious intent, and proceeds to step S320 to discard the packet without transmitting it to the internal network, thereby blocking the access to the internal network.

As described above, in accordance with the present invention, a virtual environment for accessing an external network is realized in multiple user terminals, which are to access the internal network, and packets generated in the virtual environment are transmitted to a network separation apparatus connected to the external network. The network separation apparatus analyzes whether or not the received packets are those generated in the virtual environment and checks a destination IP address of the packets. Thereafter, the network separation apparatus transmits a packet having an IP address representing the external network, among the packets generated in the virtual environment, to the external network, and identifies a packet having an IP address representing an internal network, among the packets generated in the virtual environment, as a packet attempting access the internal network with malicious intent and performs network separation in a manner to block transmission to the internal network.

While the invention has been shown and described with respect to the embodiments, the present invention is not limited thereto. It will be understood by those skilled in the art that various changes and modifications may be made without departing from the scope of the invention as defined in the following claims.

1. A network separation apparatus which allows a user terminal, connected to an internal network, to connect an external network, the apparatus comprising:
a packet transmission/reception unit configured to receive a packet generated in a virtual environment on the user terminal and transmit the packet either to the external network or the internal network;
a packet analysis unit configured to analyze the packet received from the packet transmission/reception unit; and
a packet processing unit configured to allow the packet to be transmitted to the external network or the internal network, separately, based on an analysis result of the packet from the packet analysis unit and a preset packet processing policy.

2. The network separation apparatus of claim 1, wherein, if the packet processing policy is set to transmit a packet generated in the virtual environment only to the external network, the packet processing unit allows a packet destined for transmission to the external network and blocks a packet destined for transmission to the internal network.

3. The network separation apparatus of claim 1, wherein the packet processing unit checks the destination IP address of the packet analyzed by the packet analysis unit, and if the destination IP address is an IP address representing the external network, transmits the packet to the external network.

4. The network separation apparatus of claim 2, wherein the packet processing unit checks the destination IP address of the packet analyzed by the packet analysis unit, and if the destination IP address is an IP address representing the internal network, identifies the packet as attempting malicious access to the external network and blocks the access.

5. The network separation apparatus of claim 1, wherein the packet is directly transmitted from the user terminal to the packet transmission/reception unit by tunneling.

6. A network separation system, the system comprising:
a user terminal, connected to an internal network, configured to transmit a packet generated in a virtual environment via the internal network; and
a network separation apparatus configured to analyze the packet received from the user terminal, and selectively transmitting the packet either to an external network or the internal network, separately, based on an analysis result and a preset packet processing policy.

7. The network separation system of claim 6, wherein the network separation apparatus comprises:
a packet analysis unit configured to analyze whether the packet received from the user terminal is a packet generated in the virtual environment; and
a packet processing unit configured to selectively transmit the packet to the external network or the internal network, separately, based on the analysis result of the packet from the packet analysis unit and the preset packet processing policy.

8. The network separation system of claim 6, wherein, if the packet processing policy is set to transmit a packet generated in the virtual environment only to the external network, the network separation apparatus checks the destination IP address of the analyzed packet, and if the IP address is an IP address representing the external network, the network separation apparatus transmits the packet to the external network.

9. The network separation system of claim 6, wherein, if the packet processing policy is set to transmit a packet generated in the virtual environment only to the external network, the packet separation apparatus checks the destination IP address of the analyzed packet, and if the IP address is an IP address representing the internal network, the network separation apparatus identifies the packet as attempting malicious access to the internal network and blocks the packet.

10. The network separation system of claim 6, wherein the user terminal directly transmits the packet generated in the virtual environment to the network separation apparatus by tunneling.

11. A method for network separation, the method comprising:
generating a virtual environment when there is a need for a connection between a user terminal, connected to an internal network, and an external network;
receiving a packet generated in the virtual environment;
analyzing the received packet; and
selectively transmitting the packet to either the external network or the internal network, separately, based on an analysis result of the packet and a preset packet processing policy.

12. The method of claim 11, wherein, if the packet processing policy is set to transmit a packet generated in the virtual environment only to the external network, said selectively transmitting the packet comprises allowing the packet destined for transmission to the external network and blocking the packet destined for transmission to the internal network.

13. The method of claim 12, wherein said selectively transmitting the packet comprises checking the destination IP address of the packet to transmit the packet to the external network if the destination IP address is an IP address representing the external network, and identifying the packet as attempting malicious access to the external network and blocking the packet if the destination IP address is an IP address representing the internal network.

14. The method of claim 11, wherein the packet is directly received from the user terminal by tunneling.
